(19) United States
(12) Patent Application Publication
(10) Pub. No.: US 2026/0364733 A1
(43) Pub. Date: Nov. 19, 2026

(54) APPARATUS FOR POLISHING SUBSTRATE OF SUPERCONDUCTING WIRE AND METHOD FOR MANUFACTURING SUPERCONDUCTING WIRE USING SAME

(71) Applicant: MARU L&C CO., LTD., Daegu (KR)

(72) Inventor: Dong Jin Kim, Daegu (KR)

(73) Assignee: MARU L&C CO., LTD., Daegu (KR)

(21) Appl. No.: 19/138,575

(22) PCT Filed: Jul. 5, 2024
(86) PCT No.: PCT/KR2024/009540

§ 371 Date: Jun. 12, 2025

(30) Foreign Application Priority Data
Jul. 12, 2023 (KR) 10-2023-0090596

(51) Int. Cl. B24B 29/08; B24B 49/02; B24B 55/06; H01B 12/06

(52) U.S. Cl. CPC B24B 29/08; B24B 49/02; B24B 55/06; H01B 12/06

(57) ABSTRACT

The present invention relates to an apparatus for polishing a substrate of a superconducting wire, the apparatus comprising: an unwinding unit for providing a substrate; a polishing unit for polishing the substrate provided from the unwinding unit; a cleaning unit for cleaning the substrate having been polished in the polishing unit; and a winding unit around which the substrate having been cleaned in the cleaning unit is wound, wherein the substrate is provided from the unwinding unit while having protective layers formed on both sides, respectively, and the polishing unit polishes the rear surface of the substrate.

### TECHNICAL FIELD

The present invention relates to an apparatus for polishing a substrate of a superconducting wire and a method of manufacturing a superconducting wire using the same, and more particularly, to an apparatus for polishing a substrate of a superconducting wire, which is capable of polishing a superconducting wire to have a thinner thickness to improve the performance of the superconducting wire, and a method of manufacturing a superconducting wire using the same.

### BACKGROUND ART

A superconductor can allow an electric current to flow without any loss of power. For example, a superconductor has a property that resistance becomes zero below a critical temperature. Due to this property, superconductors are being actively researched and developed for commercialization in power devices such as cables, transformers, generators, fault current limiters, nuclear fusion devices, and motors as well as medical/bio applications for magnetic resonance imaging (MRI), nuclear magnetic resonance (NMR), and the like.

In particular, high-temperature superconductor (HTS) materials, which are oxide superconductors, provide a means for transporting large amounts of current with extremely low losses at a liquid nitrogen temperature (77 K).

After a buffer layer made of Al₂O₃, Y₂O₃, MgO, or LaMnO₃ is formed on a metal substrate made of a Hastelloy or STS, a ReBaCuO layer, which is a superconducting film, is formed, Ag is formed to cover the entire surface of a wire, and the wire is finally plated with Cu to manufacture a superconducting wire.

A thickness of a commonly used Hastelloy or STS substrate is 50 μm or 60 μm, which occupies most of the volume of a superconducting wire.

The magnetic flux density of an electromagnet is proportional to the number of turns N of a coil and a current I flowing in the coil. Therefore, when a substrate of a superconducting wire becomes thinner, the number of turns of a superconducting coil can be increased, and thus an electromagnet with a higher magnetic flux density can be made.

Therefore, research and development are being conducted to develop superconducting wires with a thinner thickness.

The background art of the present invention is disclosed in Korean Patent Publication No. 10-0985122, (title of the invention: System and method for polishing surface of metal tape).

### DISCLOSURE

### Technical Problem

The present invention has been made to improve the above problems and is directed to providing an apparatus for polishing a substrate of a superconducting wire, which is capable of manufacturing a superconducting wire with a thinner thickness by polishing a substrate after manufacturing the superconducting wire, and a method of manufacturing a superconducting wire using the same.

### Technical Solution

According to the present, provided is an apparatus for polishing a substrate of a superconducting wire, the apparatus including an unwinding unit configured to provide a substrate, a polishing unit configured to polish the substrate provided by the unwinding unit, a cleaning unit configured to clean the substrate which has been polished by the polishing unit, and a winding unit on which the substrate cleaned by the cleaning unit is wound, wherein the substrate provided by the unwinding unit is provided in a state in which a protective layer is formed on two surfaces, and the polishing unit polishes a rear surface of the substrate.

The polishing unit may include a polishing tank in which a deformation preventing agent for preventing deformation of the substrate is accommodated, a plurality of polishing guide rollers configured to guide the substrate to the polishing tank, and polishing rollers configured to polish the rear surface of the substrate guided by the polishing guide rollers.

The deformation preventing agent may be an inert liquid gas.

The polishing guide roller formed at a rear end side among the polishing guide rollers may be a heating roller.

The polishing unit may include a cooling roller in contact with a front surface of the substrate to prevent deformation of the substrate, and a polishing roller disposed below the cooling roller to polish the rear surface of the substrate.

The polishing roller may be a crown roller.

The cleaning unit may include a cleaning tank in which a cleaning agent is accommodated, and a plurality of cleaning guide rollers configured to guide the substrate to the cleaning tank, and the guide roller formed at a rear end portion among the cleaning guide rollers may be a heating roller.

The apparatus may include a polishing correction unit configured to measure a thickness of the substrate to correct the polishing roller, and the polishing correction unit may include a thickness measuring unit configured to measure the thickness of the substrate that has passed through the cleaning unit, and a control unit configured to correct a polishing degree by the polishing roller according to a value measured by the thickness measuring unit.

According to the present invention, provided is a method of manufacturing a superconducting wire by using an apparatus for polishing a substrate of a superconducting wire, the method including a buffer layer formation operation of forming a buffer layer on a substrate, a superconducting layer formation operation of forming a superconducting layer on the buffer layer, a first protective layer formation operation of forming a protective layer on each of two surfaces of the substrate to protect the superconducting layer, a thickness reduction operation of reducing a thickness of the substrate on which the protective layer is formed, a second protective layer formation operation of forming a protective layer on a side surface of the substrate, and a stabilizing layer formation operation of forming a stabilizing layer on a circumferential surface of the substrate.

The thickness reduction operation may include a rear surface polishing operation of polishing a rear surface of the substrate to reduce a thickness of the substrate supplied by forming the protective layer on each of the two surfaces, a primary removal operation of removing foreign materials generated when the substrate is polished, a cleaning operation of, after the primary removal operation, cleaning the substrate, a secondary removal operation of removing foreign materials from the substrate, and a thickness correction operation of, after the secondary removal operation, measuring the thickness of the substrate to correct a polishing degree in the rear surface polishing operation.

The secondary removal operation may include spraying dried nitrogen onto the substrate that has undergone the cleaning operation and coating a surface of the substrate with nitrogen.

### Advantageous Effects

As described above, in an apparatus for polishing a substrate of a superconducting wire and a method of manufacturing a superconducting wire using the same, after a superconducting wire is manufactured, a substrate can be polished to manufacture a thinner superconducting wire, thereby obtaining an effect of manufacturing a superconducting wire with excellent properties in terms of large-current conducting, high magnetic field generation, and the like.

In the present invention, since an inert liquid gas is used as a deformation preventing agent to prevent deformation or degeneration due to heat generated during a polishing process, and an inert liquid gas is used as a cleaning agent, the deformation or degeneration of a substrate can be prevented, and also the use of moisture can be excluded, thereby obtaining an effect of protecting a superconductor that is weak to moisture and preventing moisture absorption.

A surface of a substrate is coated with nitrogen by spraying dried nitrogen from an air knife that removes foreign materials from the cleaned substrate, thereby protecting the substrate from moisture to prevent corrosion or the like.

In the present invention, a polishing roller consists of a crown roller to solve the problem of a high polishing rate at an edge due to stress during polishing, thereby obtaining an effect that the entire surface of a substrate has a uniform polishing rate.

In the present invention, it is possible to continuously measure and correct a thickness of the final substrate that has been polished by a polishing correction unit, thereby obtaining an effect that it is possible to provide a superconducting wire with excellent performance.

### DESCRIPTION OF DRAWINGS

FIG. 1 is a view for describing a structure of a superconducting wire according to the present invention.

FIG. 2 is a schematic view for describing an apparatus for polishing a superconducting wire according to the present invention.

FIG. 3 is a schematic view for describing a modified example of an apparatus for polishing a superconducting wire according to the present invention.

FIG. 4 is a view for describing a polishing roller of the apparatus for polishing a superconducting wire according to the present invention.

FIG. 5 is a flowchart for describing a method of manufacturing a superconducting wire according to the present invention.

FIG. 6 is a flowchart for describing a thickness reduction operation of the method of manufacturing a superconducting wire according to the present invention.

### MODES OF THE INVENTION

Hereinafter, exemplary embodiments of an apparatus for polishing a superconducting wire and a method of manufacturing a superconducting wire using the same according to the present invention will be described with reference to the accompanying drawings. The accompanying drawings are not necessarily to scale, and in some instances, proportions may have been exaggerated in order to clearly illustrate features of the embodiments.

Terms to be described below are terms defined in consideration of functions in the present invention and thus may vary according to intentions or customs of users and operators. Accordingly, the definitions of such terms should be made based on the content throughout the specification.

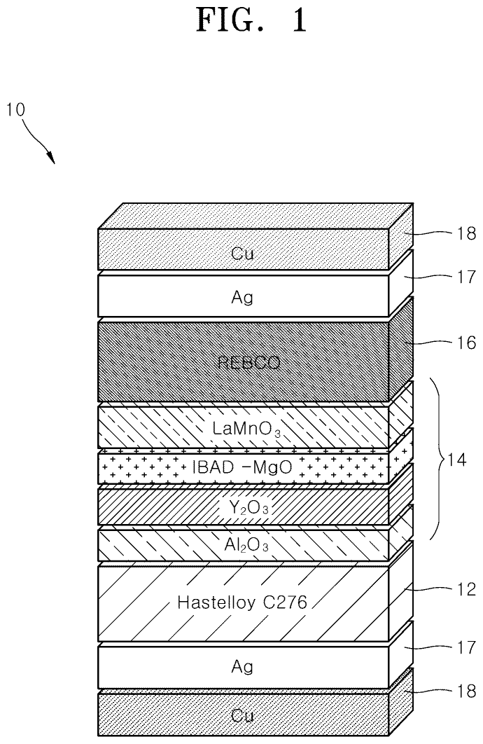

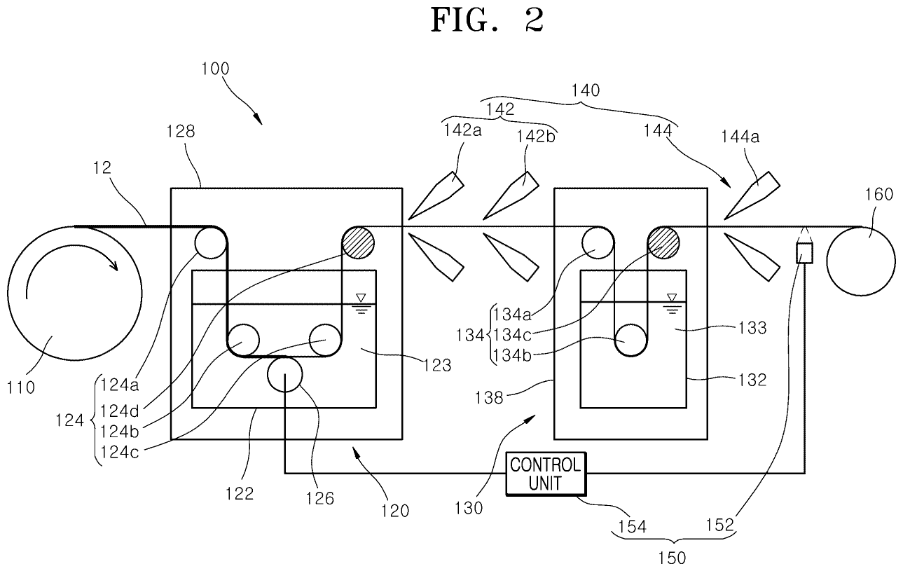

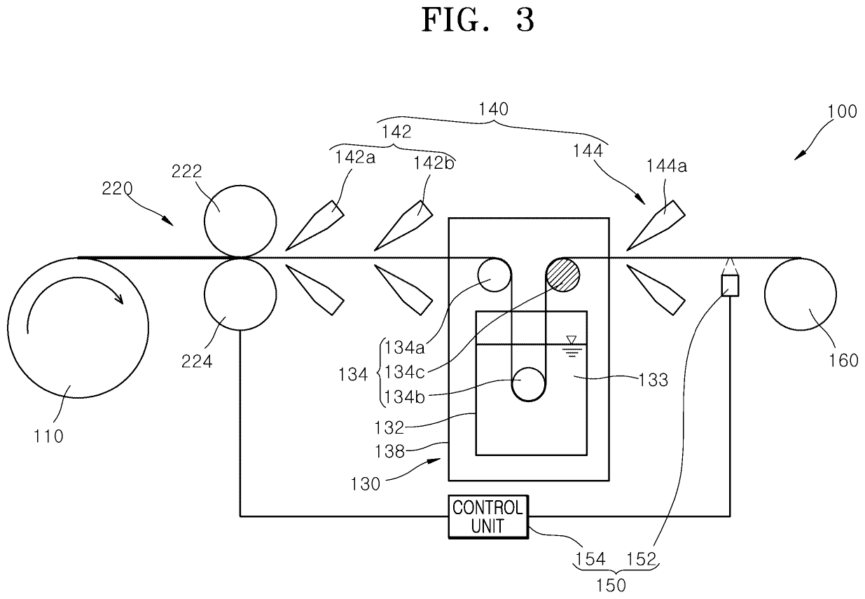

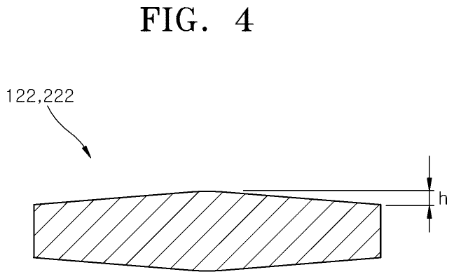

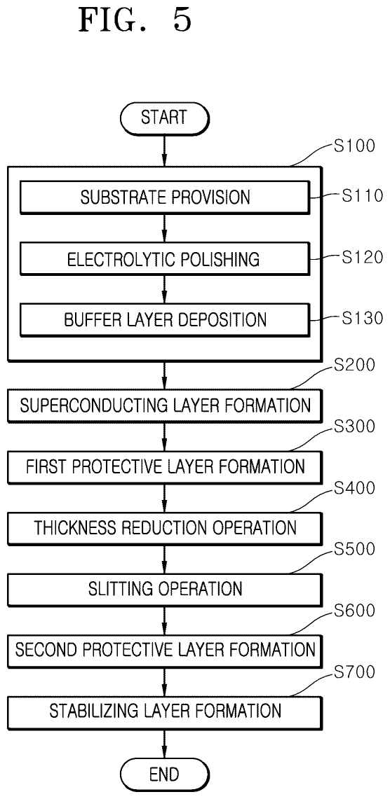

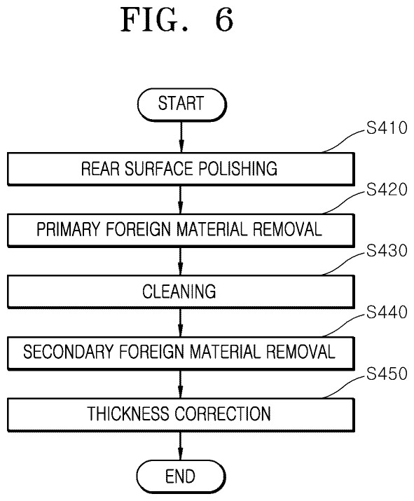

FIG. 1 is a view for describing a structure of a superconducting wire according to the present invention. FIG. 2 is a schematic view for describing an apparatus for polishing a superconducting wire according to the present invention. FIG. 3 is a schematic view for describing a modified example of an apparatus for polishing a superconducting wire according to the present invention. FIG. 4 is a view for describing a polishing roller of the apparatus for polishing a superconducting wire according to the present invention. FIG. 5 is a flowchart for describing a method of manufacturing a superconducting wire according to the present invention. FIG. 6 is a flowchart for describing a thickness reduction operation of the method of manufacturing a superconducting wire according to the present invention.

Referring to FIGS. 1 to 4, an apparatus 100 for polishing a substrate of a superconducting wire according to one embodiment of the present invention includes an unwinding unit 110, a polishing unit 120, a cleaning unit 130, and a winding unit 160.

The unwinding unit 110 provides a substrate 12, and the substrate 12 for polishing is wound on a feeding reel. The substrate 12 is sequentially pulled out of the unwinding unit 110 and provided to the polishing unit 120.

The winding unit 160 may be a continuous supply reel that provides the substrate 12 at a constant speed, and prevent the substrate 12 from sagging or stretching by controlling tension together with the winding unit 160 to be described below.

A transport speed of the substrate 12 may vary according to a plurality of factors such as a polishing thickness and a polishing speed.

In this case, the substrate 12 provided by the unwinding unit 110 is provided in a state in which a protective layer 17 is formed on each of two surfaces. Specifically, referring to FIG. 1, the substrate 12 may be provided in a state in which a buffer layer 14 and a superconducting layer 16 are formed on the substrate 12, and the protective layer 17 formed such that Ag covers the entire surface is formed only on each of two surfaces of the substrate 12. That is, the substrate 12 is manufactured into a superconducting wire 10 and then provided to the unwinding unit 110.

The polishing unit 120 polishes the substrate 12 provided by the unwinding unit 110 and includes a polishing tank 122 in which a deformation preventing agent 123 for preventing deformation of the substrate 12 is accommodated, a plurality of polishing guide rollers 124 for guiding the substrate 12 to the polishing tank 122, and a polishing roller 126 for polishing a rear surface of the substrate 12 guided by the polishing guide rollers 124.

The deformation preventing agent 123 accommodated in the polishing tank 122 is made of a non-flammable liquid gas. More specifically, the non-flammable liquid gas consists of liquid nitrogen (LN₂) or liquid helium (LHe). Since polishing is performed in the non-flammable liquid gas, deformation or degeneration due to heat can be prevented, and scattering of particles generated during polishing can also be prevented.

In the present embodiment, by using a non-flammable liquid gas as a refrigerant, a superconductor which is weak to moisture can be protected, and moisture absorption can be prevented, thereby improving the adhesion of a film during a coating process.

The polishing guide rollers 124 include first and second polishing guide rollers 124a and 124b that guide the substrate 12 into the polishing tank 122 and third and fourth polishing guide rollers 124c and 124d that guide the substrate 12 out of the polishing tank 122. In this case, a polishing guide roller 124 formed at a rear end side among the polishing guide rollers 124 consists of a heating roller. That is, the fourth polishing guide roller 124d consists of a heating roller and prevents moisture absorption on a surface of the substrate 12 pulled out of the polishing tank 122.

The polishing unit 120 performs polishing in a polishing chamber 128 in a vacuum state to prevent particle scattering and moisture absorption on the surface of the polished substrate 12.

The polishing roller 126 is provided below a space between the second polishing guide roller 124b and the third polishing guide roller 124c to polish the rear surface of the substrate 12, thereby making the substrate 12 thinner.

As shown in FIG. 3, the polishing unit 220 includes a cooling roller 222 that comes into contact with a front surface of the substrate 12 to prevent deformation of the substrate 12 and a polishing roller 224 that is located below the cooling roller 222 to polish the rear surface of the substrate 12.

That is, the cooling roller 222 comes into contact with a superconducting deposition surface and cools heat generated when the polishing roller 224 polishes the rear surface of the substrate 12, thereby preventing deformation or degeneration. The polishing roller 224 may also be cooled if necessary.

The polishing roller 126 or 224 consists of a crown roller as shown in FIG. 4. In the case of a parallel roll in which the polishing roller 126 or 224 has a circular cross section, a polishing rate at an edge of the substrate 12 is higher than that at a center due to stress during polishing. To compensate for such a polishing rate difference, it is preferable to apply a crown roller of which a diameter is large at a center and gradually decreases toward an edge of a roll.

The cleaning unit 130 cleans the substrate 12 that has been polished by the polishing unit 120 and includes a cleaning tank 132 in which a cleaning agent 133 is accommodated and a plurality of cleaning guide rollers 134 that guide the substrate 12 to the cleaning tank 132.

The cleaning guide rollers 134 include first, second, and third cleaning guide rollers 134a, 134b, and 134c that guide the substrate 12 into and out of the cleaning tank 132. In this case, the cleaning guide roller 134 formed at a rear end side among the cleaning guide rollers 134 consists of a heating roller. That is, the third cleaning guide roller 134c consists of a heating roller and prevents moisture absorption on the surface of the substrate 12 pulled out of the cleaning tank 132.

The cleaning agent 133 accommodated in the cleaning tank 132 consists of an inert liquid gas identical to the deformation preventing agent 123 such as liquid nitrogen (LN₂), liquid helium (LHe), anhydrous ethanol, or ethylene. The cleaning unit 130 performs cleaning in a cleaning chamber 138 in a vacuum state to prevent moisture absorption on the surface of the substrate 12 that has been cleaned.

The third cleaning guide roller 134c consisting of a heating roller is heated to room temperature to prevent moisture absorption upon exposure to the air.

A dust removal unit 140 is provided in front of and behind the cleaning unit 130. The dust removal unit 140 includes a first dust removal unit 142 that removes dust from the substrate 12 polished by the polishing unit 120, and a second dust removal unit 144 that finally removes dust and liquid nitrogen from the substrate 12 cleaned by the cleaning unit 130.

The first dust removal unit 142 includes a dust collection/suction portion 142a that collects/suctions dust from the polished substrate 12, and an air knife 142b that sprays high-pressure dried nitrogen, and the second dust removal unit 144 includes an air knife 144a that sprays high-pressure dried nitrogen to remove dust and liquid nitrogen from the cleaned substrate 12.

In particular, moisture may be generated on the substrate while the substrate is cleaned in the chamber 138 in a vacuum state, is exposed to the atmosphere, and is moved to a subsequent process. Dried nitrogen may be sprayed by the second dust removal unit 144 to coat the surface of the substrate 12 with nitrogen, thereby protecting the substrate 12 from moisture.

The apparatus 100 for polishing a superconducting wire according to the present embodiment includes a polishing correction unit 150 that measures a thickness of the substrate 12 to correct the polishing roller 126.

The polishing correction unit 150 includes a thickness measurement unit 154 that measures the thickness of the substrate 12 that has passed through the cleaning unit 130, and a control unit 154 that corrects a polishing degree by the polishing roller 126 according to a value measured by the thickness measurement unit 154.

The polishing degree of the substrate 12 may be immediately corrected by the polishing correction unit 150, thereby providing the superconducting wire 10 with a thickness desired by a user.

The substrate 12 of which the thickness has been reduced by completing polishing and cleaning in this way is provided to the winding unit 160. The winding unit 160 includes a winding reel on which the substrate 12 is wound.

Hereinafter, a method of manufacturing a superconducting wire by using an apparatus for polishing a substrate of a superconducting wire according to one embodiment of the present invention will be described.

The method of manufacturing a superconducting wire by using an apparatus 100 for polishing a substrate 12 of a superconducting wire according to one embodiment of the present invention includes a buffer layer formation operation S100, a superconducting layer formation operation S200, a first protective layer formation operation S300, a thickness reduction operation S400, a second protective layer formation operation S600, and a stabilizing layer formation operation S700.

First, a rolled substrate 12 is provided (S110), and an electrolytic polishing process is performed to flatten the substrate 12 (S120).

Afterwards, a buffer layer 14 is formed on a front surface of the substrate 12 (S130). The buffer layer 14 is formed as follows.

After surface treatment is performed on the buffer layer 14 using the above-described electrolytic polishing process (S120), an Al₂O₃ diffusion barrier layer is deposited on the metal substrate 12 made of a Hastelloy or STS, a Y₂O₃ seed layer is deposited on the Al₂O₃ diffusion barrier layer, and MgO and LaMnO₃ layers are sequentially deposited, thereby forming the buffer layer 14 (S130).

A superconducting layer 16 is formed on the buffer layer 14 (S200). The superconducting layer 16 is formed by depositing a ReBaCuO layer, which is a superconducting film.

After the buffer layer 14 and the superconducting layer 16 are formed on the entire surface of the substrate 12, a first protective layer 17 is formed (S300). The first protective layer 17 is formed by depositing Ag to cover two surfaces of the substrate 12 to protect a ReBaCuO superconducting metal oxide including a rare earth material.

Afterwards, the thickness reduction operation S400 is performed. The thickness reduction operation S400 is performed to reduce a thickness of the substrate 12 in a state in which the protective layer 17 is formed. In the present embodiment, in a state in which a superconducting wire 10 in which the buffer layer 14, the superconducting layer 16, and the first protective layer 17 are formed on the substrate 12 as described above is manufactured, polishing is performed to form the superconducting wire to have a thin thickness so that the superconducting wire has excellent properties in terms of large-current conducting, high magnetic field generation, and the like.

When a process of depositing the buffer layer 14 and the superconducting layer 16 is performed using a substrate thinly rolled to have a thickness of 30 μm or less, there is a problem in that it is difficult to control tension according to a structure of process equipment. However, in the present embodiment, since a rear surface of the substrate 12 is polished in a state in which the superconducting wire 10 has already been manufactured, the above problem can be solved, and the superconducting wire 10 having a thin thickness can be provided.

The thickness reduction operation S400 includes a rear surface polishing operation S410, a primary removal operation S420, a cleaning operation S430, a secondary removal operation S440, and a thickness correction operation S450.

The rear surface of the substrate 12 is polished to reduce a thickness of the substrate 12 supplied by forming the protective layer 17 on two surfaces. In this case, the substrate 12 is put into a polishing tank 122, in which an inert liquid gas (liquid nitrogen: LN₂ or liquid helium: LHe) is accommodated as a deformation preventing agent 123, through a polishing guide roller 124, and the rear surface is polished in the polishing tank 122 by a polishing roller 126, thereby reducing the thickness of the substrate 12 without deformation or degeneration (S410). In this case, the polishing guide roller 124 located at a rear end side among the polishing guide rollers 124 is formed as a heating roller to prevent moisture absorption due to external exposure.

The rear surface polishing operation S410 may also be performed using a cooling roller 222 and a polishing roller 224 which are vertically disposed in parallel as shown in FIG. 3. If necessary, the polishing roller 224 may also be cooled to prevent the deformation or degeneration of the substrate 12 due to heat generated during polishing.

Afterwards, from the substrate 12 of which the rear surface has been polished, dust generated during polishing removed by a first dust removal unit 142 (S420). The first dust removal unit 142 includes a dust collection/suction portion 142a and an air knife 142b and collects/suctions dust from the substrate 12 and sprays high-pressure dried nitrogen to remove the dust.

After the primary removal operation S420, the cleaning operation S430 of cleaning the substrate 12 is performed. The cleaning operation S430 is performed through a process in which a plurality of cleaning guide rollers 134 guide the substrate 12 to a cleaning tank 132 in which a cleaning agent 133 is accommodated, and the substrate 12 passes through the cleaning agent 133. In this case, it is preferable that the cleaning unit 130 perform cleaning in a cleaning chamber 138 in a vacuum state to prevent moisture absorption on the surface of the substrate 12, and a third cleaning guide roller 134c formed at a rear end side among the cleaning guide rollers 134 is formed as a heating roller to prevent moisture from being adsorbed when the substrate 12 is exposed to the air.

The substrate 12 that has been cleaned undergoes the secondary removal operation S440 to finally remove dust and liquid nitrogen. In the secondary removal operation S440, the removal is performed by high-pressure dried nitrogen through a second dust removal unit 144 formed as an air knife 144a.

In the secondary removal operation S440, dried nitrogen is sprayed onto the substrate 12 that has undergone the cleaning operation S430 to coat the surface of the substrate 12 with nitrogen, thereby protecting the substrate 12 from moisture.

After the secondary removal operation S440, thickness correction operation S450 of measuring the thickness of the substrate 12 to correct a polishing degree in the rear surface polishing operation S410 is performed.

In the thickness correction operation S450, the thickness of the substrate 12 that has passed through the second dust removal unit 144 is measured by a thickness measurement unit 154, and a polishing degree by the polishing roller 126 is corrected by a control unit 154 according to a value measured by the thickness measurement unit 154. In this way, the thickness of the final substrate 12 of which the rear surface has been polished may be continuously measured and corrected, thereby providing the superconducting wire 10 with excellent performance.

Thereafter, a slitting operation S500 of cutting the substrate 12 at predetermined intervals is performed, in the slitting operation S500, the substrate 12 is cut at predetermined intervals by a slitter to form unit substrates 12, and for the substrate 12 cut in this way, a protective layer 17 formed by coating a side surface of the substrate 12 with Ag is formed through the second protective layer formation operation S600. The stabilizing layer formation operation S700 of forming a stabilizing layer 18 on the entire circumferential surface of the substrate 12 through Cu electroplating is performed, thereby completing the superconducting wire 10.

As described above, according to the present invention, after the superconducting wire is manufactured, the substrate can be polished to manufacture the superconducting wire having a thinner thickness, thereby providing a superconducting wire having excellent properties in terms of large-current conducting, high magnetic field generation, and the like.

The present invention has been described with reference to embodiments shown in the drawings, but this is merely illustrative, and those skilled in the art will understand that various modifications and other equivalent embodiments are possible therefrom.

Therefore, the true technical protection scope of the present invention should be defined by the appended claims.

1. An apparatus for polishing a superconducting wire, the apparatus comprising:
an unwinding unit configured to provide a substrate;
a polishing unit configured to polish the substrate provided by the unwinding unit;
a cleaning unit configured to clean the substrate which has been polished by the polishing unit; and
a winding unit on which the substrate cleaned by the cleaning unit is wound,
wherein the substrate provided by the unwinding unit is provided in a state in which a protective layer is formed on two surfaces, and
the polishing unit polishes a rear surface of the substrate.

2. The apparatus of claim 1, wherein the polishing unit includes:
a polishing tank in which a deformation preventing agent for preventing deformation of the substrate is accommodated;
a plurality of polishing guide rollers configured to guide the substrate to the polishing tank; and
polishing rollers configured to polish the rear surface of the substrate guided by the polishing guide rollers.

3. The apparatus of claim 2, wherein the deformation preventing agent is an inert liquid gas.

4. The apparatus of claim 2, wherein the polishing guide roller formed at a rear end side among the polishing guide rollers is a heating roller.

5. The apparatus of claim 1, wherein the polishing unit includes:
a cooling roller in contact with a front surface of the substrate to prevent deformation of the substrate; and
a polishing roller disposed below the cooling roller to polish the rear surface of the substrate.

6. The apparatus of claim 2, wherein the polishing roller is a crown roller.

7. The apparatus of claim 1, wherein the cleaning unit includes a cleaning tank in which a cleaning agent is accommodated, and a plurality of cleaning guide rollers configured to guide the substrate to the cleaning tank, and
the guide roller formed at a rear end portion among the cleaning guide rollers is a heating roller.

8. The apparatus of claim 2, comprising a polishing correction unit configured to measure a thickness of the substrate to correct the polishing roller,
wherein the polishing correction unit includes:
a thickness measuring unit configured to measure the thickness of the substrate that has passed through the cleaning unit; and
a control unit configured to correct a polishing degree by the polishing roller according to a value measured by the thickness measuring unit.

9. A method of manufacturing a superconducting wire, the method comprising:
a buffer layer formation operation of forming a buffer layer on a substrate;
a superconducting layer formation operation of forming a superconducting layer on the buffer layer;
a first protective layer formation operation of forming a protective layer on each of two surfaces of the substrate to protect the superconducting layer;
a thickness reduction operation of reducing a thickness of the substrate on which the protective layer is formed;
a second protective layer formation operation of forming a protective layer on a side surface of the substrate; and
a stabilizing layer formation operation of forming a stabilizing layer on a circumferential surface of the substrate.

10. The method of claim 9, wherein the thickness reduction operation includes:
a rear surface polishing operation of polishing a rear surface of the substrate to reduce a thickness of the substrate supplied by forming the protective layer on each of the two surfaces;
a primary removal operation of removing foreign materials generated when the substrate is polished;
a cleaning operation of, after the primary removal operation, cleaning the substrate;
a secondary removal operation of removing foreign materials from the substrate; and
a thickness correction operation of, after the secondary removal operation, measuring the thickness of the substrate to correct a polishing degree in the rear surface polishing operation.

11. The method of claim 10, wherein the secondary removal operation includes spraying dried nitrogen onto the substrate that has undergone the cleaning operation and coating a surface of the substrate with nitrogen.
